(19) United States
(12) Patent Application Publication
(10) Pub. No.: US 2022/0320499 A1
(43) Pub. Date: Oct. 6, 2022

(54) ANODE FOR ALL-SOLID-STATE BATTERY

(71) Applicant: TOYOTA JIDOSHA KABUSHIKI KAISHA, Toyota-shi Aichi-ken (JP)

(72) Inventor: Shinya Shiotani, Nagoya-shi (JP)

(21) Appl. No.: 17/689,544

(22) Filed: Mar. 8, 2022

(30) Foreign Application Priority Data
Mar. 30, 2021 (JP) 2021-057492

(51) Int. Cl. H01M 4/36; H01M 10/0562

(52) U.S. Cl. CPC H01M 4/366; H01M 10/0562; H01M 2004/021

(57) ABSTRACT

Provided is an anode for an all-solid-state battery which suppresses delamination, to suppress a resistance increase of the all-solid-state battery due to repeated charge and discharge. The anode for an all-solid-state battery includes an anode current collector, an inner electrode layer, and a surface electrode layer, the inner electrode layer and the surface electrode layer being stacked in an order mentioned on the anode current collector, wherein the inner electrode layer and the surface electrode layer each contain a solid electrolyte particle, a mean particle diameter of the solid electrolyte particle contained in the surface electrode layer is larger than a mean particle diameter of the solid electrolyte particle contained in the inner electrode layer, and a thickness of the surface electrode layer is at most 20% of a total thickness of the inner electrode layer and the surface electrode layer.

### CROSS-REFERENCE TO RELATED APPLICATIONS

This application is based upon and claims the benefit of priority of the prior Japanese Patent Application No. 2021-057492, filed on Mar. 30, 2021, the entire contents of which are incorporated herein by reference.

### FIELD

The present disclosure relates to an anode for an all-solid-state battery.

### BACKGROUND

An all-solid-state battery is a battery having a cathode layer, an anode layer, and a solid electrolyte layer between the cathode layer and the anode layer, and has the advantage of an easier achievement of a simplified safety device than the liquid-based battery including an electrolytic solution containing a combustible organic solvent. A particle diameter of a solid electrolyte particle in an electrode for a solid-state battery is suitably adjusted for the purpose of improving the battery performance.

For example, Patent Literature 1 discloses an all-solid-state battery wherein the rate characteristics thereof are improved by forming a layer made from a solid electrolyte particle having a small particle diameter in the vicinity of a surface of an electrode, and disposing a solid electrolyte particle having a large particle diameter among an active material, so that the mean particle diameter of the solid electrolyte in the electrode is larger on the electrolyte side and smaller on a current collector side. Patent Literature 2 discloses a solid electrolyte battery wherein an electrode material is aligned in such a way that the particle diameter thereof is large on an interface side with a solid electrolyte, and is small on the opposite side of the interface, and a fluidized material for the solid electrolyte is supplied to the electrode material side where the particle diameter is large, and is hardened. Patent Literature 3 discloses a lithium ion secondary battery characterized in that the ratio of a particle diameter of a solid electrolyte to a particle diameter of a cathode active material or an anode active material ranges from 1/10 to 1/3. Patent Literature 4 discloses a solid-state battery that has an anode layer comprising a particulate metal or metal compound and a particulate sulfide solid electrolyte material, wherein the ratio of the mean particle diameter of the metal or metal compound and the mean particle diameter of the sulfide solid electrolyte material is at least 2 and less than 7. Patent Literature 5 discloses an all-solid-state battery wherein a mean particle diameter of a solid electrolyte particle contained in an active material layer is smaller than a mean particle diameter of an active material particle, and is 1 to 3 μm.

### CITATION LIST

### Patent Literature

Patent Literature 1: WO 2014/132333 A1
Patent Literature 2: JP H 09-102321 A
Patent Literature 3: JP 2016-001596 A
Patent Literature 4: JP 2014-035812 A
Patent Literature 5: JP 2012-243644 A

### SUMMARY

### Technical Problem

In the all-solid-state battery disclosed in Patent Literature 1, the solid electrolyte particle having a small mean particle diameter is disposed in the vicinity of the surface of the electrode, and the solid electrolyte particle having a large mean particle diameter is disposed so as to fill spaces among an active material particle, and a ferroelectric substance is used for binding the active material particle and the solid electrolyte particle. Joining an electrode layer and a separator layer (hereinafter may be referred to as a solid electrolyte layer) is joining a solid electrolyte in the electrode layer and a solid electrolyte in the separator layer, and thus is capable of improvement in view of suppression of delamination due to repeated charge and discharge. In addition, delamination may increase the resistance of the all-solid-state battery due to repeated charge and discharge.

In view of the above circumstances, an object of the present disclosure is to provide such an anode for an all-solid-state battery which suppresses delamination, to suppress a resistance increase of the all-solid-state battery due to repeated charge and discharge.

### Solution to Problem

As one aspect to solve the problems, the present disclosure is provided with an anode for an all-solid-state battery, the anode including an anode current collector, an inner electrode layer, and a surface electrode layer, the inner electrode layer and the surface electrode layer being stacked in an order mentioned on the anode current collector, wherein the inner electrode layer and the surface electrode layer each contain a solid electrolyte particle, a mean particle diameter of the solid electrolyte particle contained in the surface electrode layer is larger than a mean particle diameter of the solid electrolyte particle contained in the inner electrode layer, and a thickness of the surface electrode layer is at most 20% of a total thickness of the inner electrode layer and the surface electrode layer.

### Effects

The anode for an all-solid-state battery according to the present disclosure is capable of suppressing delamination, and suppressing a resistance increase of the all-solid-state battery due to repeated charge and discharge.

### BRIEF DESCRIPTION OF DRAWINGS

FIG. 1 is a schematic view of an anode layer 10 that is one embodiment;

FIG. 2 shows the result of measurement of the resistance increase ratio to the proportion on an electrode surface according to Examples and Comparative Examples; and

FIG. 3 is a schematic cross-sectional view of an all-solid-state battery 100.

### DESCRIPTION OF EMBODIMENTS

(Anode Layer 10)

An anode for an all-solid-state battery according to the present disclosure will be described, making reference to an anode layer 10 that is one embodiment. The following embodiment is an example of the present disclosure. The present disclosure is not limited to the following embodiment.

In the present description, “mean particle diameter” means a particle diameter at a 50% integrated value (D₅₀) in a volume-based particle diameter distribution that is measured using a laser diffraction and scattering method.

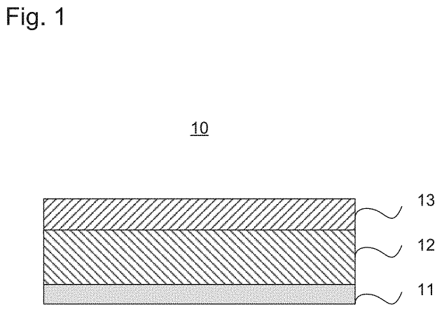

FIG. 1 is a cross-sectional schematic view of an anode layer 10 in the stacking direction. The anode layer 10 is provided with a surface electrode layer 13, an inner electrode layer 12 and an anode current collector 11. As shown in FIG. 1, the inner electrode layer 12 and the surface electrode layer 13 are stacked in this order on the anode current collector 11.

<Inner Electrode Layer 12>

The inner electrode layer 12 is a layer interposed between the anode current collector 11 and the surface electrode layer 13. The inner electrode layer 12 contains a solid electrolyte described later. A mean particle diameter of this solid electrolyte particle is not particularly limited, but for example, ranges from 0.5 μm to 1.5 μm in view of formation of an ion conduction path in the electrode.

<Surface Electrode Layer 13>

The surface electrode layer 13 is a layer interposed between the inner electrode layer 12 on the anode current collector 11, and a solid electrolyte layer 30 described later. The surface electrode layer 13 contains a solid electrolyte described later. A mean particle diameter of this solid electrolyte particle is larger than the mean particle diameter of the solid electrolyte particle of the inner electrode layer 12, and in some embodiments, for example, at least 2.5 μm. As described later, the mean particle diameter of the solid electrolyte particle of the surface electrode layer 13 is approximately the same as the mean particle diameter of a solid electrolyte particle of the solid electrolyte layer 30 in view of an anchor effect.

A total thickness of the inner electrode layer 12 and the surface electrode layer 13 is not particularly limited, but may be suitably set according to a desired battery performance. For example, the total thickness ranges from 0.1 μm to 1 mm or ranges from 0.1 μm to 100 μm. In some embodiments, a thickness of the surface electrode layer 13 is at most 20% of the total thickness of the inner electrode layer 12 and the surface electrode layer 13 or at most 10% thereof. The surface electrode layer 13 contains the solid electrolyte particle of a predetermined mean particle diameter. In some embodiments, the lower limit of the thickness of the surface electrode layer 13 is at least the mean particle diameter of this solid electrolyte particle contained in the surface electrode layer 13.

The smaller the particle diameter of a solid electrolyte particle is, the better in view of formation of a conduction path. However, it is known that when there is only a solid electrolyte particle of a small particle diameter, a coated and pressed electrode layer becomes smooth, which weakens the anchor effect between the electrode layer and a solid electrolyte layer. In the anode for an all-solid-state battery according to the present disclosure, a conventional solid electrolyte particle of a small particle diameter is used for the inner electrode layer 12, and the solid electrolyte particle of a larger particle diameter than that of the inner electrode layer 12 is disposed in the surface electrode layer 13. Thus, the anode suppresses deterioration of the performance due to a larger particle diameter of a solid electrolyte particle, and the anchor effect between the electrode layer and the solid electrolyte layer suppresses delamination. Further, the suppression of delamination results in suppression of a resistance increase of the all-solid-state battery due to repeated charge and discharge.

The inner electrode layer 12 and the surface electrode layer 13 contains at least an anode active material. Any known anode active material that may be used for all-solid-state batteries may be used as the anode active material. Examples of the anode active material include silicon-based active materials such as Si and Si alloys; carbon-based active materials such as graphite and hard carbon; any oxide-based active materials such as lithium titanate; and lithium-based active materials such as metallic lithium and lithium alloys. C, Si and the like are known as expandable and shrinkable active materials that. A mean particle diameter of the anode active material is not particularly limited, but for example, ranges from 0.1 μm to 50 μm. The inner electrode layer 12 and the surface electrode layer 13 contain, for example, the anode active material in the range of 30 wt % and 90 wt %.

Examples of the solid electrolytes in the inner electrode layer 12 and the surface electrode layer 13 include oxide solid electrolytes and sulfide solid electrolytes, in some embodiments sulfide solid electrolytes are used. Examples of the oxide solid electrolytes include Li₇La₃Zr₂O₁₂, Li_{7-X}La₃Zr_{1-X}Nb_{X}O₁₂, Li₃PO₄, and Li_{3+X}PO_{4-X}N_{X} (LiPON). Examples of the sulfide solid electrolyte include Li₃PS₄, Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂. Contents of the solid electrolytes in the inner electrode layer 12 and the surface electrode layer 13 are not particularly limited. For example, the inner electrode layer 12 and the surface electrode layer 13 contain the solid electrolytes in the range of, for example, 10 wt % and 70 wt %.

The inner electrode layer 12 and the surface electrode layer 13 may optionally contain a conductive aid. Examples of the conductive aid include carbon materials such as acetylene black, Ketjenblack, and vapor grown carbon fiber (VGCF), and metallic materials such as nickel, aluminum and stainless steel. A content of the conductive aid in the inner electrode layer 12 and the surface electrode layer 13 is not particularly limited. For example, the inner electrode layer 12 and the surface electrode layer 13 contain the conductive aid in the range of 0.1 wt % and 20 wt %.

The inner electrode layer 12 and the surface electrode layer 13 may optionally contain a binder. Examples of the binder include butadiene rubber (BR), butyl rubber (IIR), acrylate-butadiene rubber (ABR), polyvinylidene fluoride (PVdF), and polyvinylidene fluoride-hexafluoropropylene copolymer (PVDF-HFP). A content of the binder in the inner electrode layer 12 and the surface electrode layer 13 is not particularly limited. For example, the inner electrode layer 12 and the surface electrode layer 13 contain the binder in the range of 0.1 wt % and 10 wt %.

<Anode Current Collector 11>

The anode current collector 11 may be formed of metal foil, metal mesh, and the like. In some embodiments, metal foil is used. Examples of a metal to form the anode current collector 11 include materials of any known anode current collector such as SUS, Cu, Ni, Fe, Ti, Co and Zn, in some embodiments Cu is used, and in some embodiments electrolytic copper is used. A thickness of the anode current collector 11 is not particularly limited, but may be the same as conventional ones. For example, the thickness ranges from 0.1 μm and 1 mm.

There is no particular limitations on a method of preparing the anode layer 10. The anode layer 10 may be prepared according to a known method. For example, the anode layer 10 may be prepared by: preparing the surface electrode layer 13 by mixing the material to constitute the surface electrode layer 13 with a solvent to form a slurry, applying the slurry to a substrate or the solid electrolyte layer 30 described later, and drying the slurry; preparing the inner electrode layer 12 by mixing the material to constitute the inner electrode layer 12 with a solvent to form a slurry, applying the slurry to a substrate or the anode current collector 11, and drying the slurry; and laminating and pressing the inner electrode layer and the surface electrode layer.

[All-Solid-State Battery]

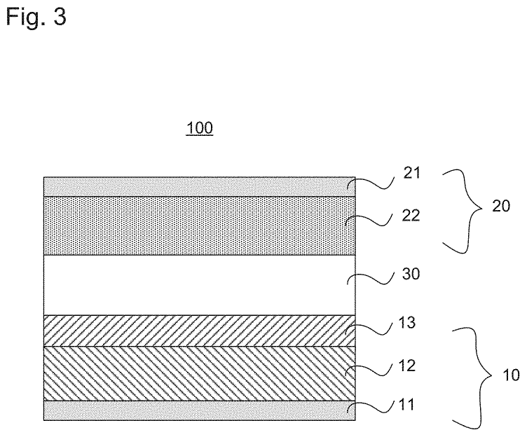

Next, an all-solid-state battery with the anode layer 10 for an all-solid-state battery according to the present disclosure will be described, using an all-solid-state battery 100 that is one embodiment. FIG. 3 is a schematic cross-sectional view of the all-solid-state battery 100.

As shown in FIG. 3, the all-solid-state battery 100 has a cathode electrode layer 20 including a cathode current collector 21 and a cathode layer 22, the solid electrolyte layer 30, and the anode layer 10 including the surface electrode layer 13, the inner electrode layer 12 and the anode current collector 11. The all-solid-state battery 100 is formed by staking the cathode current collector 21, the cathode layer 22, the solid electrolyte layer 30, the surface electrode layer 13, the inner electrode layer 12 and the anode current collector 11 in this order. The all-solid-state battery 100 may be formed of one stacked body, or of a plurality of the stacked bodies in view of improvement in the battery performance. One and another stacked bodies among a plurality of the stacked bodies may share some components.

(Cathode Electrode Layer 20)

The cathode electrode layer 20 is provided with the cathode current collector 21 and the cathode layer 22. The cathode layer 22 is stacked on the cathode current collector 21.

<Cathode Layer 22>

The cathode layer 22 is a layer interposed between the cathode current collector 21 and the solid electrolyte layer 30 described later. The cathode layer 22 contains at least a cathode active material. Any known cathode active material that may be used for all-solid-state lithium ion batteries may be used as the cathode active material. Examples of the cathode active material include lithium-containing composite oxides such as lithium cobaltate and lithium nickelate. A mean particle diameter of the cathode active material is not particularly limited, but for example, ranges from 5 μm to 50 μm. The cathode layer 22 contains the cathode active material in the range of, for example, 50 wt % and 99 wt %. A surface of the cathode active material may be coated with an oxide layer such as a lithium niobate layer, a lithium titanate layer and a lithium phosphate layer.

The cathode layer 22 may optionally contain a solid electrolyte. Any of the solid electrolytes same as those used in the inner electrode layer 12 and the surface electrode layer 13 may be used. A content of the solid electrolyte in the cathode layer 22 is not particularly limited. For example, the cathode layer 22 contains the solid electrolyte in the range of 1 wt % and 50 wt %.

The cathode layer 22 may optionally contain a conductive aid. The conductive aid same as that used in the inner electrode layer 12 and the surface electrode layer 13 may be used. A content of the conductive aid in the cathode layer 22 is not particularly limited. For example, the cathode layer 22 contains the conductive aid in the range of 0.1 wt % and 10 wt %.

The cathode layer 22 may optionally contain a binder. The binder same as that used in the inner electrode layer 12 and the surface electrode layer 13 may be used. A content of the binder in the cathode layer 22 is not particularly limited. For example, the cathode layer 22 contains the binder in the range of 0.1 wt % and 10 wt %.

A thickness of the cathode layer 22 is not particularly limited, but may be suitably set according to a desired battery performance. For example, the thickness ranges from 0.1 μm to 1 mm.

<Cathode Current Collector 21>

The cathode current collector 21 may be formed of metal foil, metal mesh, and the like. In some embodiments, metal foil is used. Examples of a metal to form the cathode current collector 21 include SUS, and materials of any known cathode current collectors such as Al and Ni. In some embodiments, Al is used. A thickness of the cathode current collector 21 is not particularly limited, but may be the same as conventional ones. For example, the thickness ranges from 0.1 μm to 1 mm.

There is no particular limitations on a method of preparing the cathode electrode layer 20. The cathode electrode layer 20 may be prepared according to a known method. For example, the cathode electrode layer 20 may be prepared by mixing the material to constitute the cathode layer 22 with a solvent to form a slurry, applying the slurry to a substrate or the cathode current collector 21, and drying the slurry.

(Solid Electrolyte Layer 30)

The solid electrolyte layer 30 is a separator layer containing the solid electrolyte. Any of the solid electrolytes same as those used in the inner electrode layer 12 and the surface electrode layer 13 may be used. A mean particle diameter of the solid electrolyte particle used in the solid electrolyte layer 30 is not limited, but for example, ranges from 0.5 μm to 100 μm. In view of an anchor effect, the solid electrolyte particle has a mean particle diameter approximately same as that of the surface electrode layer 13. Here, “approximately same” means approximately 50% to 150% of the mean particle diameter of the solid electrolyte particle used in the surface electrode layer 13, approximately 75% to 125% thereof, or the same as the mean particle diameter of the solid electrolyte particle. For example, the solid electrolyte layer contains the solid electrolyte in the range of 50 wt % and 99 wt %.

The solid electrolyte layer 30 may optionally contain a binder. The binder same as that used in the inner electrode layer 12 and the surface electrode layer 13 may be used. A content of the binder in the solid electrolyte layer 30 is not particularly limited. For example, the solid electrolyte layer 30 contains the binder in the range of 0.1 wt % and 10 wt %.

There is no particular limitations on a method of preparing the solid electrolyte layer 30. The solid electrolyte layer 30 may be prepared according to a known method. For example, the solid electrolyte layer 30 may be prepared by mixing the material to constitute the solid electrolyte layer 30 with a solvent to form a slurry, applying the slurry to a substrate, and drying the slurry.

(Preparing All-Solid-State Battery)

There are no particular limitations on a method of preparing the all-solid-state battery 100. The all-solid-state battery 100 may be prepared according to a known method. For example, the all-solid-state battery 100 may be prepared by: pressing and stacking the cathode electrode layer 20 including the cathode current collector 21 and the cathode layer 22, the solid electrolyte layer 30, and the anode layer 10 including the surface electrode layer 13, the inner electrode layer 12 and the anode current collector 11 in this order; connecting cathode and anode terminals to the obtained stacked body; and placing the obtained stacked body between laminated film or the like and welding them.

### EXAMPLES

[Preparing All-Solid-State Battery]

Total eleven types of all-solid-state batteries for evaluation of Examples 1 to 4 and Comparative Examples 1 to 7 were prepared according to the preparing method described as follows.

(Preparing Cathode Electrode Layer)

Butyl butyrate, a butyl butyrate solution of a 5 wt % polyvinylidene fluoride-based binder, a lithium nickel cobalt aluminum oxide of a cathode active material, vapor grown carbon fiber (VGCF) as a conductive aid, and a sulfide solid electrolyte (Li₂S—P₂S₅ based glass ceramics containing LiI, mean particle diameter D₅₀=0.8 μm) that is such that the volume ratio of the cathode active material and the sulfide solid electrolyte material was 75:25 were added into a vessel made from PP (polypropylene). Next, the resultant was stirred with an ultrasonic dispersive device (UH-50 manufactured by SMT Corporation) for 30 seconds, and was shaken with a mixer (TTM-1 manufactured by Sibata Scientific Technology Ltd.) for 30 minutes. Thereafter Al foil was coated with the resultant using an applicator according to a blade method. The coated slurry of a cathode electrode layer was air-dried, and thereafter dried on a hot plate at 100° C. for 30 minutes, and then the resultant cathode electrode layer was obtained.

(Preparing Solid Electrolyte Layer)

Heptane, a heptane solution of a 5 wt % butyl rubber-based binder, and a sulfide solid electrolyte material (Li₂S—P₂S₅ based glass ceramics containing LiI, mean particle diameter D₅₀=2.5 μm) were added into a vessel made from PP. Next, the resultant was stirred with an ultrasonic dispersive device (UH-50 manufactured by SMT Corporation) for 30 seconds, and was shaken with a mixer (TTM-1 manufactured by Sibata Scientific Technology Ltd.) for 30 minutes. Thereafter Al foil was coated with the resultant using an applicator according to a blade method. The coated slurry of a solid electrolyte layer was air-dried, and thereafter dried on a hot plate at 100° C. for 30 minutes, and then the resultant solid electrolyte layer was obtained.

(Preparing Anode Layer)

### Comparative Example 1

Butyl butyrate, a butyl butyrate solution of a 5 wt % polyvinylidene fluoride-based binder, a silicon particle of an anode active material, vapor grown carbon fiber (VGCF) as a conductive aid, and a sulfide solid electrolyte (Li₂S—P₂S₅ based glass ceramics containing LiI, mean particle diameter D₅₀=0.8 μm) that is such that the volume ratio of the anode active material and the sulfide solid electrolyte material was 50:50 were added into a vessel made from PP. Next, the resultant was stirred with an ultrasonic dispersive device (UH-50 manufactured by SMT Corporation) for 30 seconds, and was shaken with a mixer (TTM-1 manufactured by Sibata Scientific Technology Ltd.) for 30 minutes. Thereafter Ni foil was coated with the resultant using an applicator according to a blade method. The coated slurry of an anode layer was air-dried, and thereafter dried on a hot plate at 100° C. for 30 minutes, and then the resultant anode layer was obtained.

### Comparative Example 2

An anode layer according to Comparative Example 2 was the same as in Comparative Example 1 except that an electrolyte having a mean particle diameter D₅₀=2.5 μm was used as the sulfide solid electrolyte.

### Comparative Example 3

An inner electrode layer according to Comparative Example 3 was prepared in the same manner as the anode layer in Comparative Example 1 except that the coating gap was changed so that the inner electrode layer was 50% of the entire electrode after the inner electrode layer and a surface electrode layer were laminated. The surface electrode layer according to Comparative Example 3 was prepared in the same manner as the anode layer in Comparative Example 2 except that Al foil was coated with the surface electrode layer and that the coating gap was changed so that the surface electrode layer was 50% of the entire electrode after the inner electrode layer and the surface electrode layer were laminated. The laminating, and preparation of the electrode were performed in such a way that: the inner electrode layer and the surface electrode layer were laminated, and pressed at 1 ton/cm²; and the Al foil was removed therefrom. Then, the anode layer was obtained.

### Comparative Example 4

An inner electrode layer according to Comparative Example 4 was prepared in the same manner as the anode layer in Comparative Example 1 except that the coating gap was changed so that the inner electrode layer was 70% of the entire electrode after the inner electrode layer and the surface electrode layer were laminated. The surface electrode layer according to Comparative Example 4 was prepared in the same manner as in Comparative Example 3 except that the coating gap was changed so that the surface electrode layer was 30% of the entire electrode after the inner electrode layer and the surface electrode layer were laminated. The laminating, and preparation of the electrode were performed in the same manner as in Comparative Example 3.

### Example 1

An inner electrode layer according to Example 1 was prepared in the same manner as the anode layer in Comparative Example 1 except that the coating gap was changed so that the inner electrode layer was 80% of the entire electrode after the inner electrode layer and the surface electrode layer were laminated. The surface electrode layer according to Example 1 was prepared in the same manner as in Comparative Example 3 except that the coating gap was changed so that the surface electrode layer was 20% of the entire electrode after the inner electrode layer and the surface electrode layer were laminated. The laminating, and preparation of the electrode were performed in the same manner as in Comparative Example 3.

### Example 2

An inner electrode layer according to Example 2 was prepared in the same manner as the anode layer in Comparative Example 1 except that the coating gap was changed so that the inner electrode layer was 90% of the entire electrode after the inner electrode layer and the surface electrode layer were laminated. The surface electrode layer according to Example 2 was prepared in the same manner as in Comparative Example 3 except that the coating gap was changed so that the surface electrode layer was 10% of the entire electrode after the inner electrode layer and the surface electrode layer were laminated. The laminating, and preparation of the electrode were performed in the same manner as in Comparative Example 3.

### Comparative Example 5

An anode layer according to Comparative Example 5 was the same as in Comparative Example 1 except that an electrolyte having a mean particle diameter D₅₀=3 μm was used as the sulfide solid electrolyte.

### Comparative Example 6

An inner electrode layer according to Comparative Example 6 was prepared in the same manner as in Comparative Example 3. A surface electrode layer according to Comparative Example 6 was prepared in the same manner as in Comparative Example 5 except that Al foil was coated with the surface electrode layer and that the coating gap was changed so that the surface electrode layer was 50% of the entire electrode after the inner electrode layer and the surface electrode layer were laminated. The laminating, and preparation of the electrode were performed in the same manner as in Comparative Example 3.

### Comparative Example 7

An inner electrode layer according to Comparative Example 7 was prepared in the same manner as in Comparative Example 4. A surface electrode layer according to Comparative Example 7 was prepared in the same manner as in Comparative Example 5 except that the coating gap was changed so that the surface electrode layer was 30% of the entire electrode after the inner electrode layer and the surface electrode layer were laminated. The laminating, and preparation of the electrode were performed in the same manner as in Comparative Example 3.

### Example 3

An inner electrode layer according to Example 3 was prepared in the same manner as in Example 1. A surface electrode layer according to Example 3 was prepared in the same manner as in Comparative Example 5 except that the coating gap was changed so that the surface electrode layer was 20% of the entire electrode after the inner electrode layer and the surface electrode layer were laminated. The laminating, and preparation of the electrode were performed in the same manner as in Comparative Example 3.

### Example 4

An inner electrode layer according to Example 4 was prepared in the same manner as in Example 2. A surface electrode layer according to Example 4 was prepared in the same manner as in Comparative Example 5 except that the coating gap was changed so that the surface electrode layer was 10% of the entire electrode after the inner electrode layer and the surface electrode layer were laminated. The laminating, and preparation of the electrode were performed in the same manner as in Comparative Example 3.

(Preparing Battery for Evaluation)

The solid electrolyte layer was put into a mold of 1 cm² and pressed at 1 ton/cm². Next, the cathode was disposed on one side of the solid electrolyte layer and pressed at 1 ton/cm². Next, the anode was disposed on the other side of the solid electrolyte layer and pressed at 6 ton/cm². Cathode and anode terminals were connected to the stacked body obtained from the pressing. The obtained stacked body was placed between laminated film and welded, and then the obtained battery was prepared.

[Evaluation]

Total eleven types of the all-solid-state batteries of Examples 1 to 4 and Comparative Examples 1 to 7 were restrained with metal plates at a pressure of 5 MPa, and the following evaluations were performed thereon.

(Evaluation of Initial Characteristics)

The capacities in CCCV charging and discharging at a rate of 1/10 C were confirmed. After the confirmation of the capacities, the battery was charged at a constant current once, and then conditioned to have a voltage of 3.2 V in CCCV discharging. Next, the battery was discharged at a constant current at a rate of 1.5 C for 5 seconds, and then a resistance thereof was calculated according to the Ohm's law.

(Evaluation of Durability)

A durability test with hundred charge/discharge cycles was done. The conditions for the charge/discharge cycle test were the following: the rate was 1 C; the upper limit of the voltage in charging was 4 V; and the lower limit of the voltage in discharging was 3 V.

(Evaluation of Characteristics after Durability Test)

A resistance was calculated through the same procedures as in the evaluation of the initial characteristics. The proportion of this resistance and the initial resistance was also calculated, to calculate the resistance increase ratio by the durability test.

Table 1 shows the evaluation results of the resistances before and after the durability test and the resistance increase ratio of each of total eleven types of the all-solid-state batteries of Examples 1 to 4 and Comparative Examples 1 to 7.

TABLE 1

| | Surface electrode | | Inner electrode | | Resistance [Ω] | | Resistance |
|---|---|---|---|---|---|---|---|
| | Particle | Proportion | Particle | Proportion | | After | increase |
| | diameter [μm] | [%] | diameter [μm] | [%] | Initial | durability test | ratio [%] |
| Comparative | — | — | 0.8 | 100 | 42 | 72 | 171 |
| Example 1 | | | | | | | |
| Comparative | — | — | 2.5 | 100 | 57 | 120 | 211 |
| Example 2 | | | | | | | |
| Comparative | 2.5 | 50 | 0.8 | 50 | 52 | 101 | 194 |
| Example 3 | | | | | | | |
| Comparative | 2.5 | 30 | 0.8 | 70 | 48 | 85 | 177 |
| Example 4 | | | | | | | |
| Example 1 | 2.5 | 20 | 0.8 | 80 | 44 | 68 | 155 |
| Example 2 | 2.5 | 10 | 0.8 | 90 | 45 | 65 | 144 |
| Comparative | — | — | 3.0 | 100 | 63 | 140 | 222 |
| Example 5 | | | | | | | |
| Comparative | 3.0 | 50 | 0.8 | 50 | 60 | 121 | 202 |
| Example 6 | | | | | | | |
| Comparative | 3.0 | 30 | 0.8 | 70 | 58 | 105 | 181 |
| Example 7 | | | | | | | |
| Example 3 | 3.0 | 20 | 0.8 | 80 | 55 | 93 | 169 |
| Example 4 | 3.0 | 10 | 0.8 | 90 | 53 | 86 | 162 |

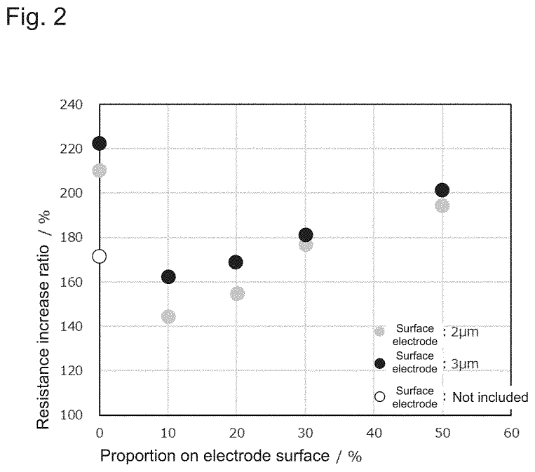

FIG. 2 shows the relationship between the proportion on an electrode surface and the resistance increase ratio after the durability test, concerning total eleven types of the all-solid-state batteries of Examples 1 to 4 and Comparative Examples 1 to 7.

[Results]

The resistance increase ratio was larger when the thickness of the surface electrode layer was at least 30% of the total thickness of the surface electrode layer and the inner electrode layer, than the case where a solid electrolyte having a different mean particle diameter from the solid electrolyte of the inner electrode layer was not used in the surface electrode layer. This is conjectured to be caused by a higher proportion of the solid electrolyte of a larger particle diameter in the anode, and attendant insufficient formation of an ion conduction path in the electrode.

In contrast, when the thickness of the surface electrode layer was at most 20% of the total thickness of the surface electrode layer and the inner electrode layer, the initial resistance tended to be higher than the case where only a solid electrolyte of a small particle diameter was used in the surface electrode layer. However, the resistance increase ratio after the durability test using charge/discharge cycles tended to lower, which suggests that the function of delamination was exercised.

In addition, the particle size dependence of the surface electrode layer was checked. The effect of suppressing the resistance increase ratio after the durability test using charge/discharge cycles was greater when the solid electrolyte of 2.5 μm was used than the case where that of 3.0 μm was used. The solid electrolyte layer laminated onto the anode layer had the same mean particle diameter of 2.5 μm as that of the surface electrode layer. This suggests that use of the solid electrolyte layer and the surface electrode layer having the same particle diameter resulted in a better fit of a degree of roughness therebetween, which made it easier to obtain an anchor effect.

### REFERENCE SIGNS LIST

100 all-solid-state battery
10 anode layer
11 anode current collector
12 inner electrode layer
13 surface electrode layer
20 cathode electrode layer
21 cathode current collector
22 cathode layer
30 solid electrolyte layer

What is claimed is:

1. An anode for an all-solid-state battery, the anode including an anode current collector, an inner electrode layer, and a surface electrode layer, the inner electrode layer and the surface electrode layer being stacked in an order mentioned on the anode current collector, wherein
the inner electrode layer and the surface electrode layer each contain a solid electrolyte particle,
a mean particle diameter of the solid electrolyte particle contained in the surface electrode layer is larger than a mean particle diameter of the solid electrolyte particle contained in the inner electrode layer, and
a thickness of the surface electrode layer is at most 20% of a total thickness of the inner electrode layer and the surface electrode layer.
